(19) United States
(12) Patent Application Publication
(10) Pub. No.: US 2014/0258527 A1
(43) Pub. Date: Sep. 11, 2014

(54) NETWORK SYSTEM, NODE DEVICE GROUP, COMPUTER APPARATUS, AND METHOD FOR TRANSMITTING AND RECEIVING SENSOR DATA

(71) Applicant: Hideki Takenaka, Shiga (JP)

(72) Inventor: Hideki Takenaka, Shiga (JP)

(73) Assignee: OMRON Corporation, Kyoto-shi, Kyoto (JP)

(21) Appl. No.: 14/355,064

(22) PCT Filed: Jan. 30, 2012
(86) PCT No.: PCT/JP2012/051922

§ 371 Date: Apr. 29, 2014

(30) Foreign Application Priority Data
Nov. 4, 2011 (JP) 2011-242577

(51) Int. Cl. H04L 12/26; G06F 17/30

(52) U.S. Cl. CPC H04L 43/0847; G06F 17/30312; G06F 17/30424; G06F 17/30554
USPC 709/224; 707/722; 707/769

(57) ABSTRACT

A computer apparatus makes an information acquisition request to any of multiple node devices. Each node device has a sensor data search section for searching a sensor data storage sections of the multiple node devices for a sensor data according to the information acquisition request and acquiring the sensor data and an information transmission section for transmitting the sensor data acquired by the sensor data search section or calculation result data acquired on the basis of the sensor data to the computer apparatus.

### BACKGROUND

1. Technical Field

The present invention relates to a network system and a method for transmitting and receiving sensor data, and more particularly to a network system which includes a plurality of node devices and sensor devices each connected to corresponding one of the node devices via wireless communication or wired communication and a method for transmitting and receiving sensor data.

The present invention also relates to a node device group and a computer apparatus included in the network system.

2. Related Art

As an example of this type of network system, there is conventionally known a system in which a data processing server as a computer apparatus is communicatively connected to first to third sensor terminals as a plurality of node devices via a network and each of the sensor terminals is accessible by one or more sensor devices via wireless communication as described in FIG. 36 of Patent Document 1 (Japanese Patent Laid-open Publication No. 2003-85213).

Patent Document 1: Japanese Patent Laid-open Publication No. 2003-85213

### SUMMARY

In the above described network system, for example, each of the sensor terminals acquires sensor data from the sensor device which is connected to the sensor terminal and saves the sensor data in a sensor data storage section included in the sensor terminal. The above described data processing server makes an information acquisition request by specifying the sensor data from any of the one or more sensor devices and acquires the sensor data from any of the plurality of sensor terminals via the network.

However, in the above described network system, when desired sensor data is saved in the plurality of sensor terminals, the data processing server needs to spend time in specifying each of the plurality of sensor terminals before making the information acquisition request. Besides, when a new sensor terminal is to be added to the network system, information about the sensor terminals needs to be updated in the data processing server, which is troublesome.

Accordingly, one or more embodiments of the present invention is a network system which includes a plurality of node devices connected to a computer apparatus via a network and sensor devices connected to each of the node devices wherein the computer apparatus can make an information acquisition request to the node devices in a short time by a simple process.

Additionally, one or more embodiments of the present invention is a node device group and the computer apparatus included in the network system and a method for transmitting and receiving the sensor data.

The present invention, according to one or more embodiments, provides a network system wherein at least one computer apparatus and a plurality of node devices are communicatively connected to each other via a network, each of the plurality of node devices is accessible by one or more sensor devices via wireless communication or wired communication, each of the node devices acquires a sensor data from the sensor device connected to the node device itself and saves the sensor data in a sensor data storage section included in the node device itself, and the computer apparatus makes an information acquisition request by specifying the sensor data from any one or more of the one or more sensor devices and acquires the sensor data from any of the plurality of node devices via the network, wherein the computer apparatus makes the information acquisition request to any of the plurality of node devices, and each of the node devices comprises: a sensor data search section for searching the sensor data storage sections of the plurality of node devices for the sensor data according to the information acquisition request and acquiring the sensor data, when the computer apparatus made the information acquisition request to the node device itself; and an information transmission section for transmitting the sensor data acquired by the sensor data search section to the computer apparatus.

In this description, the term “computer apparatus” widely refers to computers can communicate via a network whether they are called a client device, a server device, or a host computer.

The term “network” widely refers to networks such as a local area network (LAN), a wide area network (WAN), or the Internet whether they are wired or wireless.

In addition to the plurality of node devices (each of which is accessible by one or more sensor devices via wireless communication or wired communication), a node device inaccessible by the sensor device (for example, a dummy node device) may be connected to the network.

Also, in addition to the plurality of node devices (each of which has the sensor data search section), a node device which does not have the sensor data search section may be connected to the network.

The term “sensor device” widely refers to devices with sensing functions whether they form a sensor node or not.

In the network system according to one or more embodiments of the present invention, the computer apparatus makes the information acquisition request to any of the plurality of node devices. That is, the computer apparatus makes an information acquisition request by specifying the sensor data from any one or more of the one or more sensor devices via the network. The sensor data search section of the node device to which the information acquisition request was made searches the sensor data storage sections of the plurality of node devices for the sensor data according to the information acquisition request and acquires the sensor data. Then, the information transmission section of the node device transmits the sensor data acquired by the sensor data search section to the computer apparatus.

As a result, when the computer apparatus makes the information acquisition request to the node device, the computer apparatus only needs to make the information acquisition request to any of the plurality of node devices. Then, the computer apparatus neither needs to specify each of the plurality of node devices before making the information acquisition request nor needs to maintain information including which one of the node devices saves the desired sensor data. Therefore, the computer apparatus can make the information acquisition request to the node devices in a short time by the simple process. Further, any special software program and setting are not required for the computer apparatus and the information acquisition request can be made by a general-purpose computer apparatus.

In the network system according to an embodiment, each of the plurality of node devices has a calculation section for getting calculation result data by performing a calculation based on the sensor data acquired by the sensor data search section, the computer apparatus makes the information acquisition request by specifying the calculation result data, and the information transmission section of the node device which holds the calculation result data specified by the computer apparatus transmits the calculation result data to the computer apparatus.

In the network system according to the embodiment, the information transmission section of the node device to which the information acquisition request was made transmits the calculation result data calculated by the calculation section to the computer apparatus. Therefore, the computer apparatus can access the calculation result data by neither taking trouble nor spending time in performing a calculation based on the sensor data acquired by the sensor data search section.

In the network system according to an embodiment, each of the plurality of node devices has a first graph creation section for creating a graph based on the sensor data acquired by the sensor data search section, the computer apparatus makes the information acquisition request by specifying data of the graph, and the information transmission section of the node device which holds the data of the graph specified by the computer apparatus transmits the data of the graph to the computer apparatus.

In the network system according to the embodiment, the information transmission section of the node device to which the information acquisition request was made transmits the data of the graph created by the first graph creation section to the computer apparatus. Therefore, the computer apparatus can access the data of the graph by neither taking trouble nor spending time in creating the graph based on the sensor data acquired by the sensor data search section.

In the network system according to an embodiment, each of the node devices has a second graph creation section for creating a graph based on the calculation result data calculated by the calculation section, the computer apparatus makes the information acquisition request by specifying data of the graph, and the information transmission section of the node device which holds the data of the graph specified by the computer apparatus transmits the data of the graph to the computer apparatus.

In the network system according to the embodiment, the information transmission section of the node device to which the information acquisition request was made transmits the data of the graph created by the second graph creation section on the basis of the calculation result data to the computer apparatus. Therefore, the computer apparatus can access the data of the graph by neither taking trouble nor spending time in creating the graph based on the calculation result data.

In the network system according to an embodiment, the computer apparatus makes a first information acquisition request to a first node device among the plurality of node devices and concurrently makes a second information acquisition request different from the first information acquisition request to a second node device different from the first node device.

In the network system according to the embodiment, the computer apparatus makes the first information acquisition request to the first node device among the plurality of node devices and concurrently makes the second information acquisition request different from the first information acquisition request to the second node device different from the first node device. As a result, the embodiment can distribute the loads among the plurality of node devices. Therefore, the embodiment can improve the performance of the whole network system.

The term “load” on the node device in this description widely refers to the utilization rate of a CPU (central processing unit) in the node device, the number and the amount of the sensor data managed by the node device, the number of times that the node device returns the sensor data to the computer apparatus within the above described time period, the number of times that the node device processes the sensor data within the above described time period, and the like.

The network system according to an embodiment further comprises: a node load detection section for detecting a load on each of the node devices every certain period of time, and a load leveling section for switching the node device that received the information acquisition request to a proper node device for responding to the information acquisition request to level out the loads among the plurality of node devices.

In the network system according to the embodiment, the node load detection section detects a load on each of the node devices every certain period of time. Then, the load leveling section switches the node device to respond to the information acquisition request from the node device that received the information acquisition request to the proper node device for responding to the information acquisition request to level out the loads among the plurality of node devices. Specifically, the proper node device for responding to the information acquisition request is the node device with the smallest load or the node device with the load below a threshold value. As a result, the embodiment can level out the loads among the plurality of node devices. Therefore, the embodiment can improve the performance of the whole network system. For example, the embodiment can avoid a situation in which any of the plurality of node devices has a trouble in responding to the request made by the computer apparatus with the sensor data. Further, the network system can always keep good performance even if the amount of calculation undertaken by any of the node devices, the network traffic, and the number of sensor data collected by each of the sensor devices change every moment.

In the network system according to an embodiment, the load leveling section includes a decision section provided for each of the plurality of node devices, and the decision section provided for a third node device and the decision section provided for a fourth node device among the plurality of node devices make a decision about switching the node device to respond to the information acquisition request between the third node device and the fourth node device to level out the loads between the third node device and the fourth node device.

In the network system according to the embodiment, the load leveling section includes the decision section provided for each of the plurality of node devices. The decision section provided for the third node device and the decision section provided for the third node device among the plurality of node devices make a decision about switching the node device to respond to the information acquisition request between the third node device and the fourth node device to level out the loads between the third node device and the fourth node device. According to the decision, the node device to respond to the information acquisition request is switched between the third node device and the fourth node device. Therefore, even if any of the plurality of node devices is broken down, for example, the network system can make a decision without interruption by using the node device other than the broken node device since the function is not concentrated in a particular one of the node devices. Further, even if any of the plurality of node devices is replaced by a new model node device, the network system can promptly carry out the changeover since the new model node device is not required to have a particular function different from that of the other node devices.

In the network system according to an embodiment, the computer apparatus comprises: a fault detection section for detecting a fault in a connection between the computer apparatus and the node device to which the information acquisition request was made; and an information acquisition request switch section for stopping to make the information acquisition request to the node device to which the information acquisition request was made and making the information acquisition request to any of the plurality of node devices other than the node device to which the information acquisition request was made, when the fault detection section detected the fault.

In the network system according to the embodiment, the fault detection section detects a fault in the connection between the computer apparatus and the node device to which the information acquisition request was made. When the fault detection section detected the fault, the information acquisition request switch section stops to make the information acquisition request to the node device to which the information acquisition request was made and makes the information acquisition request to any of the plurality of node devices other than the node device to which the information acquisition request was made. Therefore, even if the fault is detected, the information acquisition request switch section can switch the node device to which the information acquisition request was made to any of the plurality of node devices other than the node device to which the information acquisition request was made and automatically make the information acquisition request to any of the plurality of node devices other than the node device to which the information acquisition request was made. As a result, fault-tolerance can be realized.

In the network system according to an embodiment, the fault detection section determines that the fault occurred when data was not transmitted from the information transmission section within a predetermined time period after the information acquisition request was made.

In the network system according to the embodiment, when data was not transmitted from the information transmission section within a predetermined time period after the information acquisition request was made, the fault detection section determines that the fault occurred. As a result, the network system can more certainly detect the fault.

The present invention, according to one or more embodiments, provides a node device group comprising a plurality of node devices in a network system wherein at least one computer apparatus and a plurality of node devices are communicatively connected to each other via a network, each of the plurality of node devices is accessible by one or more sensor devices via wireless communication or wired communication, each of the node devices acquires a sensor data from the sensor device connected to the node device itself and saves the sensor data in a sensor data storage section included in the node device itself, the computer apparatus makes an information acquisition request by specifying the sensor data from any one or more of the one or more sensor devices and acquires the sensor data from any of the plurality of node devices via the network, and the computer apparatus makes the information acquisition request to any of the plurality of node devices, wherein each of the node devices comprises: a sensor data search section for searching the sensor data storage sections of the plurality of node devices for the sensor data according to the information acquisition request and acquiring the sensor data, when the computer apparatus made the information acquisition request to the node device itself; and an information transmission section for transmitting the sensor data acquired by the sensor data search section to the computer apparatus.

In the network system comprising the node device group according to one or more embodiments of the present invention, the computer apparatus makes the information acquisition request to any of the plurality of node devices. That is, the computer apparatus makes an information acquisition request by specifying the sensor data from any one or more of the one or more sensor devices via the network. The sensor data search section of the node device to which the information acquisition request was made searches the sensor data storage sections of the plurality of node devices for the sensor data according to the information acquisition request and acquires the sensor data. Then, the information transmission section of the node device transmits the sensor data acquired by the sensor data search section to the computer apparatus.

As a result, when the computer apparatus made the information acquisition request to the node device, the computer apparatus only needs to make the information acquisition request to any of the plurality of node devices. Then, the computer apparatus neither needs to specify each of the plurality of node devices before making the information acquisition request nor needs to maintain information including which one of the node devices saves the desired sensor data. Therefore, the computer apparatus can make the information acquisition request to the node devices in a short time by the simple process. Further, any special software program and setting are not required for the computer apparatus and the information acquisition request can be made by a general-purpose computer apparatus.

The present invention, according to one or more embodiments, provides a computer apparatus in a network system wherein at least one computer apparatus and a plurality of node devices are communicatively connected to each other via a network, each of the plurality of node devices is accessible by one or more sensor devices via wireless communication or wired communication, each of the node devices acquires a sensor data from the sensor device connected to the node device itself and saves the sensor data in a sensor data storage section included in the node device itself, the computer apparatus makes an information acquisition request by specifying the sensor data from any one or more of the one or more sensor devices and acquires the sensor data from any of the plurality of node devices via the network, and each of the node devices comprises: a sensor data search section for searching the sensor data storage sections of the plurality of node devices for the sensor data according to the information acquisition request and acquiring the sensor data, when the computer apparatus made the information acquisition request to the node device itself; and an information transmission section for transmitting the sensor data acquired by the sensor data search section to the computer apparatus, wherein the computer apparatus makes the information acquisition request to any of the plurality of node devices.

In the network system including the computer apparatus according to one or more embodiments of the present invention, the computer apparatus makes the information acquisition request to any of the plurality of node devices. That is, the computer apparatus makes an information acquisition request by specifying the sensor data from any one or more of the one or more sensor devices via the network. The sensor data search section of the node device to which the information acquisition request was made searches the sensor data storage sections of the plurality of node devices for the sensor data according to the information acquisition request and acquires the sensor data. Then, the information transmission section of the node device transmits the sensor data acquired by the sensor data search section to the computer apparatus.

As a result, when the computer apparatus made the information acquisition request to the node device, the computer apparatus only needs to make the information acquisition request to any of the plurality of node devices. Then, the computer apparatus neither needs to specify each of the plurality of node devices before making the information acquisition request nor needs to maintain information including which one of the node devices saves the desired sensor data. Therefore, the computer apparatus can make the information acquisition request to the node devices in a short time by the simple process. Further, any special software program and setting are not required for the computer apparatus and the information acquisition request can be made by a general-purpose computer apparatus.

The present invention, according to one or more embodiments, provides a method for transmitting and receiving sensor data in a network system wherein at least one computer apparatus and a plurality of node devices are communicatively connected to each other via a network, each of the plurality of node devices is accessible by one or more sensor devices via wireless communication or wired communication, each of the node devices acquires a sensor data from the sensor device connected to the node device itself and saves the sensor data in a sensor data storage section included in the node device itself, and the computer apparatus makes an information acquisition request by specifying the sensor data from any one or more of the one or more sensor devices and acquires the sensor data from any of the plurality of node devices via the network, wherein the method for transmitting and receiving sensor data comprises steps of: causing the computer apparatus to make the information acquisition request to any of the plurality of node devices; causing a sensor data search section of the node device to which the information acquisition request was made to search the sensor data storage sections of the plurality of node devices for the sensor data according to the information acquisition request and to acquire the sensor data; and causing an information transmission section of the node device to which the information acquisition request was made to transmit the sensor data acquired by the sensor data search section to the computer apparatus.

In the method for transmitting and receiving sensor data according to one or more embodiments of the present invention, the computer apparatus makes the information acquisition request to any of the plurality of node devices. That is, the computer apparatus makes an information acquisition request by specifying the sensor data from any one or more of the one or more sensor devices via the network. The sensor data search section of the node device to which the information acquisition request was made searches the sensor data storage sections of the plurality of node devices for the sensor data according to the information acquisition request and acquires the sensor data. Then, the information transmission section of the node device transmits the sensor data acquired by the sensor data search section to the computer apparatus.

As a result, when the computer apparatus made the information acquisition request to the node device, the computer apparatus only needs to make the information acquisition request to any of the plurality of node devices to make the information acquisition request to the node devices. Then, the computer apparatus neither needs to specify each of the plurality of node devices before issuing the information acquisition request nor needs to maintain information including which one of the node devices saves the desired sensor data. Therefore, the computer apparatus can make the information acquisition request to the node devices in a short time by the simple process. Further, any special software program and setting are not required for the computer apparatus and the information acquisition request can be made by a general-purpose computer apparatus.

According to the network system, the node device group, the computer apparatus, and the method for transmitting and receiving sensor data of the present invention, it is possible to realize a network system allows the computer apparatus to make an information acquisition request to the node devices in a short time by a simple process.

### BRIEF DESCRIPTION OF THE DRAWINGS

FIG. 1 is a diagram illustrating a schematic configuration of a network system according to one or more embodiments of the present invention.

FIG. 2 is a diagram illustrating a block configuration of a client PC (personal computer) included in the network system according to one or more embodiments of the present invention.

FIG. 3 is a diagram illustrating a block configuration of a node device included in the network system according to one or more embodiments of the present invention.

FIG. 4 is a diagram illustrating a block configuration of a sensor device included in the network system according to one or more embodiments of the present invention.

FIG. 5 is a diagram illustrating constituent elements from the viewpoint of functionality of a CPU and a memory included in the node device according to one or more embodiments of the present invention.

FIG. 6 is a diagram illustrating constituent elements from the viewpoint of functionality of a memory included in the sensor device according to one or more embodiments of the present invention.

FIG. 7 is a diagram describing operation of the client PC for acquiring sensor data according to one or more embodiments of the present invention.

FIG. 8 is a diagram describing operation of the client PC for acquiring results of the temperature-humidity index calculation according to one or more embodiments of the present invention.

FIG. 9 is a table showing the sensor data needed by the node device to calculate the temperature-humidity indices and the results of the temperature-humidity index calculation according to one or more embodiments of the present invention.

FIG. 10 is a diagram describing operation of the client PC for acquiring graphs showing time series variations of the electric energies according to one or more embodiments of the present invention.

FIG. 11A is a table showing data sections needed by the node device to create graphs showing time series variations of the electric energies according to one or more embodiments of the present invention.

FIG. 11B is a graph showing the time series variations of the electric energies created by the node device according to one or more embodiments of the present invention.

FIG. 12 is a diagram illustrating constituent elements from the viewpoint of functionality of a CPU and a memory included in the node device according to one or more embodiments of the present invention.

FIG. 13 is a diagram illustrating constituent elements from the viewpoint of functionality of a CPU (central processing section) included in the client PC according to one or more embodiments of the present invention.

FIG. 14 is a diagram illustrating operation when a fault occurred in a connection between the client PC and the node device to which the information acquisition request was made by the client PC in accordance with one or more embodiments of the present invention.

### DETAILED DESCRIPTION

The present invention will be described in detail by embodiments illustrated in the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. Further, the structures according to the embodiments which will be described later are merely illustrative, and the present invention is not intended to be restricted to the structures according to these embodiments.

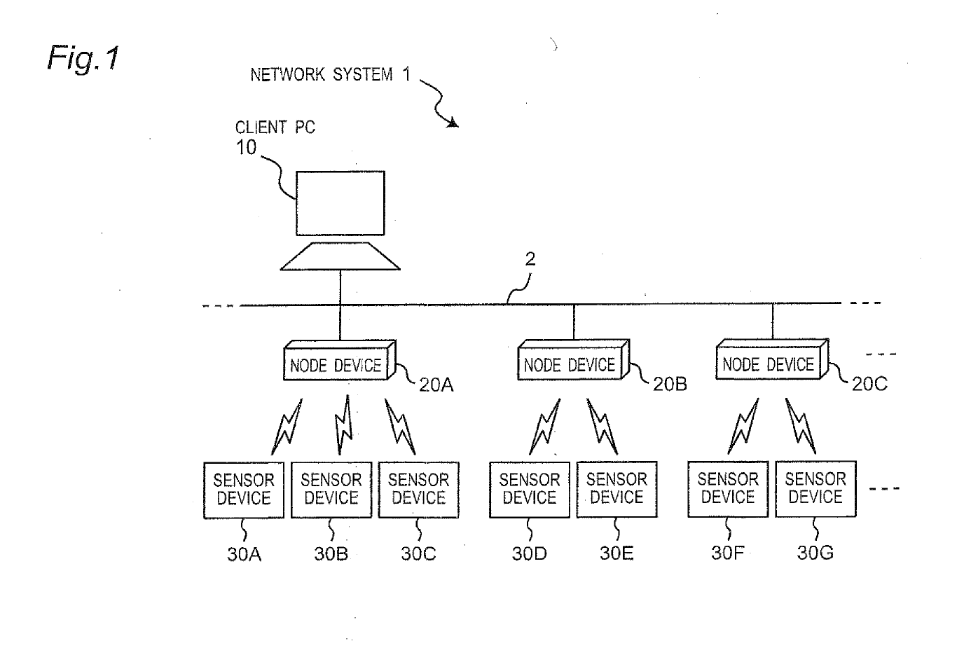

FIG. 1 is a diagram illustrating a schematic configuration of a network system (the entire system is denoted by a reference symbol 1) according to an embodiment of the present invention.

The network system 1 includes a client PC (personal computer) 10 as a computer apparatus and a plurality of node devices 20A, 20B, 20C, . . . as a node device group. The client PC 10 and the node devices 20A, 20B, 20C, . . . are communicatively connected to each other via a LAN (local area network) 2 as a network. Each of the plurality of node devices 20A, 20B, 20C, . . . is accessible by one or more sensor devices 30A, 30B, 30C, 30D, 30E, 30F, 30G, . . . via wireless communication (in this example, Wi-Fi (registered trademark) as a wireless LAN).

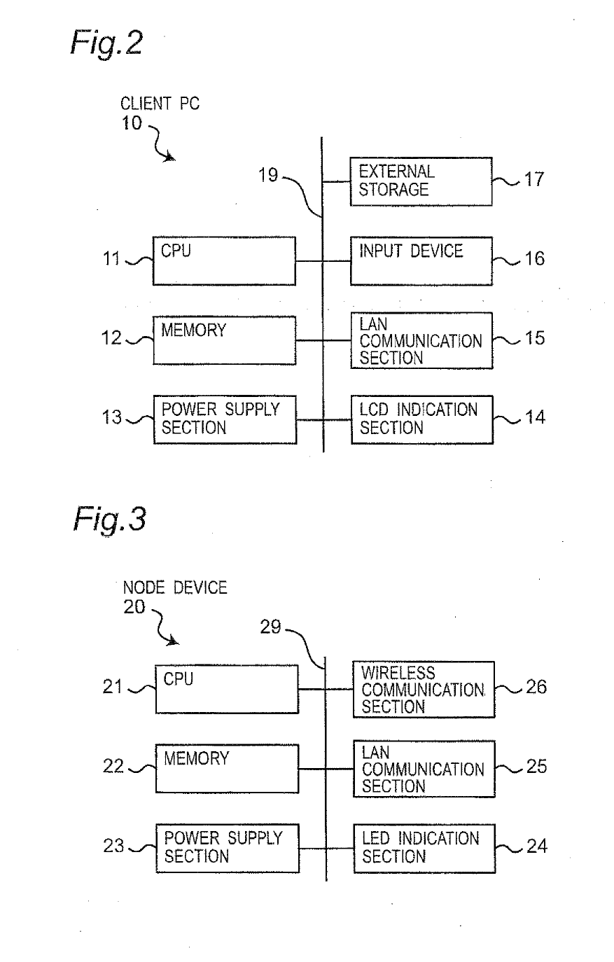

As illustrated in a block configuration of FIG. 2, the client PC 10 includes a CPU (central processing unit) 11, a memory 12, a power supply section 13, an LCD (liquid crystal display element) indication section 14 as a display section, a LAN communication section 15, an input device 16 as an input section, and an external storage 17. These constituent elements 11, 12, 13, 14, 15, 16, and 17 are communicatively connected to each other via wiring 19. The CPU 11 controls the operation of the entire client PC 10. The memory 12 includes a DRAM (dynamic random access memory) and stores various types of data. The power supply section 13 supplies the power to the respective constituent elements 11, 12, 13, 14, 15, 16, and 17 at a constant voltage (5V, 12V, or the like). The LCD indication section 14 displays respective images according to the control by the CPU 11. The LAN communication section 15 functions to allow the client PC 10 to communicate with the node devices 20A, 20B, 20C, . . . , and other (not shown) computer apparatuses, terminal devices, and the like via the LAN 2. The input device 16 includes a keyboard and a mouse and functions to allow a user to input various types of information and instructions to the client PC 10. The external storage 17 includes a hard disk drive and an optical disk and stores an operating system (OS) and application software (program) for the client PC 10.

As illustrated in a block configuration of FIG. 3, each of the node devices 20 (denoted by a common reference symbol 20 for representing the node devices 20A, 20B, 20C, . . . ) includes a CPU 21, a memory 22, a power supply section 23, an LED (light-emitting diode) indication section 24, a LAN communication section 25 as an information transmission section, and a wireless communication section 26. These constituent elements 21, 22, 23, 24, 25, and 26 are communicatively connected to each other via wiring 29. In this example, the CPU 21 operates at a clock frequency of 1.1 GHz and controls the operation of the entire node device 20. In this example, the memory 22 includes a flash memory and a DRAM (with a storage capacity of 512 MB) and stores an OS (in this example, Linux (registered trademark)), a program, and various types of data for the node device 20. The power supply section 23 supplies the power to the respective constituent elements 21, 22, 23, 24, 25, and 26 at a constant voltage (in this example, 5V). While the power is supplied by the power supply section 23 to the constituent elements, the LED indication section 24 lights the LED (not shown) to indicate that the node device 20 is active. The LAN communication section 25 functions to allow the node device 20 to communicate with the client PC 10, the other node devices, and other (not shown) computer apparatuses, terminal devices, and the like via the LAN 2. The wireless communication section 26 functions to allow the node device 20 to communicate with the sensor devices 30A, 30B, 30C, via the wireless LAN. In this example, a maximum of 64 sensor devices can connect to each of the node devices 20 via the wireless LAN.

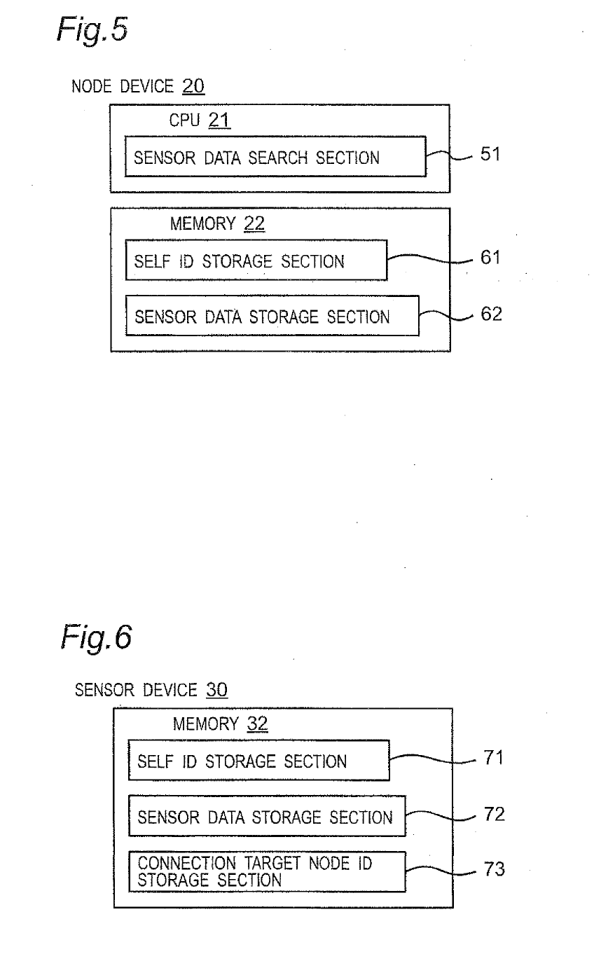

As illustrated in FIG. 5, the memory 22 of each of the node devices 20 has a self-ID storage section 61 which stores an identification number (ID) for identifying the node device 20 for the wireless LAN connection. A sensor data storage section 62 stores a sensor data from the sensor device which is connected to the node device 20 via the wireless LAN.

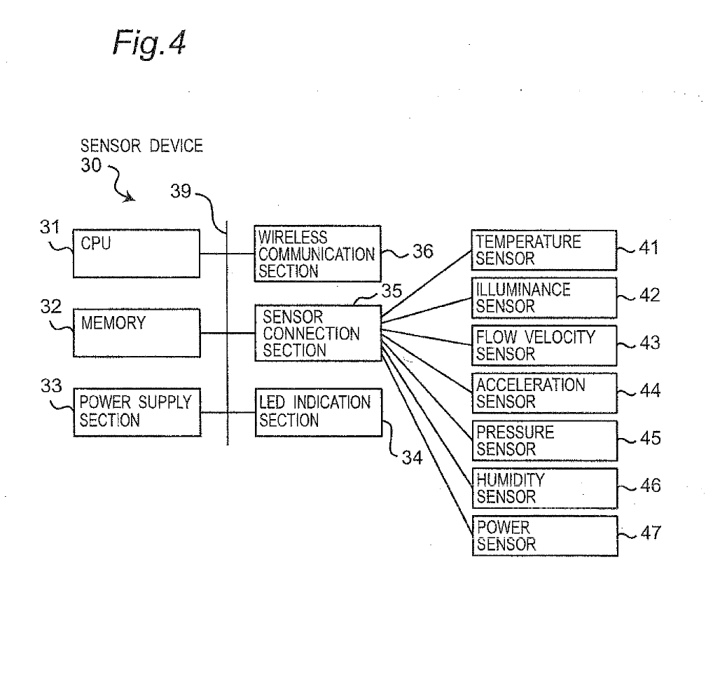

As illustrated in a block configuration of FIG. 4, each of the sensor devices 30 (denoted by a common reference symbol 30 for representing the sensor devices 30A, 30B, 30C, . . . ) includes a CPU 31, a memory 32, a power supply section 33, an LED indication section 34, a sensor connection section 35, and a wireless communication section 36. These constituent elements 31, 32, 33, 34, 35, and 36 are communicatively connected to each other via wiring 39. According to the purpose of the sensor device 30, one or some or all of a temperature sensor 41, an illuminance sensor 42, a flow velocity sensor 43, an acceleration sensor 44, a pressure sensor 45, a humidity sensor 46, and a power sensor 47 are connected to the sensor connection section 35. The sensors 41, 42, 43, 44, 45, 46, and 47 may be contained in a casing of the sensor device 30 or attached to the outside of the casing of the sensor device 30. The CPU 31 controls the operation of the entire sensor device 30. In this example, the memory 32 includes a flash memory and a DRAM and stores a program and various types of data for the sensor device 30. The power supply section 33 supplies the power to the respective constituent elements 31, 32, 34, 35, and 36 and the sensors 41, 42, 43, 44, 45, 46, and 47 at a constant voltage (in this example, 3 V). The LED indication section 34 includes a plurality of LEDs (not shown) and lights or flashes the respective LEDs according to the control by the CPU 31. As a result, the LED indication section 34 indicates the respective states such as whether the power supply of the sensor device 30 is on or off and whether the sensor device 30 is in wireless communication with any of the node devices 20A, 20B, 20C, . . . . The sensor connection section 35 functions to capture a sensor data from the sensor(s) which is connected to the sensor connection section 35 among the temperature sensor 41, the illuminance sensor 42, the flow velocity sensor 43, the acceleration sensor 44, the pressure sensor 45, the humidity sensor 46, and the power sensor 47 into the sensor device 30 which includes the sensor connection section 35. As a result, the sensor device 30 autonomously acquires the sensor data without receiving any particular instruction from outside. The wireless communication section 36 functions to allow the sensor device 30 which includes the wireless communication section 36 to communicate with any of the node devices 20A, 20B, 20C, . . . via the wireless LAN.

As illustrated in FIG. 6, the memory 32 of each of the sensor devices 30 has a self-ID storage section 71 which stores an identification number (ID) for identifying the sensor device 30 of the memory 32 for the wireless LAN connection. A sensor data storage section 72 stores the sensor data which has been captured into the sensor device 30. A connection target node ID storage section 73 stores an identification number (ID) of the node device (any one of the node devices 20A, 20B, 20C, . . . ) which is to be connected with the sensor device 30 via wireless communication.

In the example of FIG. 1, the three sensor devices 30A, 30B, and 30C are connected to the node device 20A via the wireless LAN but are not connected to the other node devices 20B, 20C, . . . . The two sensor devices 30D and 30E are connected to the node device 20B via the wireless LAN but are not connected to the other node devices 20A, 20C, . . . . The two sensor devices 30F, 30G, . . . are connected to the node device 20C via the wireless LAN but are not connected to the other node devices 20A, 20B, . . . .

According to such a connection configuration, the node device 20A acquires the sensor data from the sensor devices 30A, 30B, and 30C which are connected to the node device 20A via the wireless LAN and saves the sensor data in (the sensor data storage section 62 of) the memory 22 included in the node device 20A. The node device 20B acquires the sensor data from the sensor devices 30D and 30E which are connected to the node device 20B via the wireless LAN and saves the sensor data in the memory 22 included in the node device 20B. Also, the node device 20C acquires the sensor data from the sensor devices 30F and 30G which are connected to the node device 20C via the wireless LAN and saves the sensor data in the memory 22 included in the node device 20C. Each of the node devices 20A, 20B, 20C, . . . never directly receives the sensor data from the sensor device which is not connected to itself.

The client PC 10 makes an information acquisition request via the LAN 2 by specifying the sensor data from any one or more of the one or more sensor devices 30A, 30B, 30C, . . . or the calculation result data acquired on the basis of the sensor data.

As described above, when the information acquisition request is to be made, in case that the desired sensor data is saved, for example, in the plurality of node devices 20A, 20B, 20C, . . . , there is a problem of taking time for the client PC 10 to need to make the information acquisition request by specifying each of the plurality of node devices. Besides, when a new node device is to be added to the network system, there is a problem of requiring additional work for the client PC 10 to need to be updated.

### First Configuration Example

In a first configuration example of the present network system 1, from the viewpoint of functionality, the CPU 21 of each of the node devices 20 has a sensor data search section 51 as illustrated in FIG. 5 (The sensor data search section 51 is implemented as a software program.).

The sensor data search section 51 of each of the node devices 20 searches the sensor data storage section 62 of each of the node devices 20A, 20B, 20C, . . . for the sensor data according to the information acquisition request from the client PC 10 and acquires the sensor data. Then, the LAN communication section 25 (see FIG. 3) of each of the node devices 20 transmits the sensor data acquired by the sensor data search section 51 to the client PC 10. Further, the LAN communication section 25 transmits the sensor data to the client PC 10.

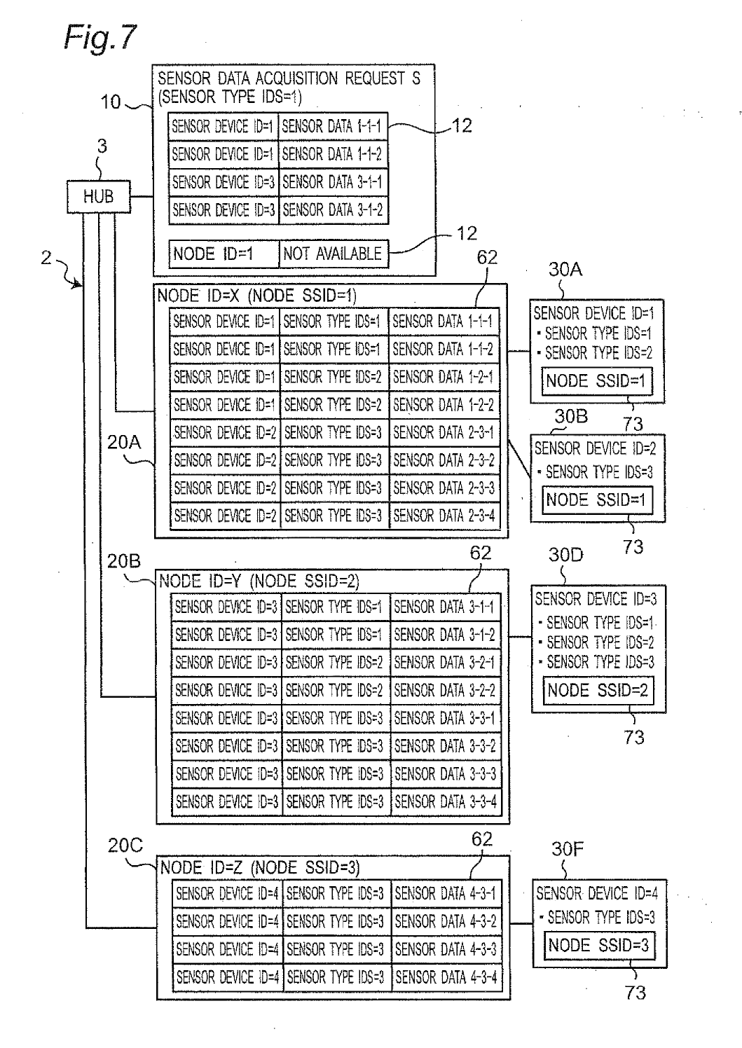

Now, processes from the issuance of a sensor data acquisition request S by the client PC 10 to transmission of the sensor data to the client PC 10 will be described in detail with reference to FIG. 7 (The reference symbols in FIGS. 4, 5 and 6 will be used as required.).

As illustrated in FIG. 7, it is assumed that the ID of the node device 20A is X (NODE ID=X), the ID of the node device 20B is Y (NODE ID=Y), and the ID of the node device 20C is Z (NODE ID=Z). It is also assumed that a service set identifier (SSID) of the node device 20A is 1 (NODE SSID=1), the SSID of the node device 20B is 2 (NODE SSID=2), and the SSID of the node device 20C is 3 (NODE SSID=3).

It is also assumed that the ID of the sensor device 30A is 1 (sensor device ID=1), the ID of the sensor device 30B is 2 (sensor device ID=2), the ID of the sensor device 30D is 3 (sensor device ID=3), and the ID of the sensor device 30F is 4 (sensor device ID=4). To the sensor device 30A, the temperature sensor 41 and the humidity sensor 46 are connected. The power sensor 47 is connected to the sensor device 30B. The temperature sensor 41, the humidity sensor 46, and the power sensor 47 are connected to the sensor device 30D. The power sensor 47 is connected to the sensor device 30F. Here, it is also assumed that a sensor type ID of the temperature sensor 41 is 1 (IDS=1), the sensor type ID of the humidity sensor 46 is 2 (IDS=2), and the sensor type ID of the power sensor 47 is 3 (IDS=3).

The sensor devices 30A and 30B which store “NODE SSID=1” in the connection target node ID storage sections 73 are connected to the node device 20A via the wireless LAN. The sensor device 30D which stores “NODE SSID=2” in the connection target node ID storage section 73 is connected to the node device 20B via the wireless LAN. Further, the sensor device 30F which stores “NODE SSID=3” in the connection target node ID storage section 73 is connected to the node device 20C via the wireless LAN. Via the LAN 2 and a HUB 3, the node devices 20A, 20B, and 20C are connected to each other and also to the client PC 10.

First, the sensor devices 30A, 30B, 30D, and 30F take measurements to acquire the sensor data every fixed period and transmit the sensor data to the respective node devices the sensor devices 30A, 30B, 30D, and 30F are connected to via the wireless LAN.

Then, the node devices 20A, 20B, and 20C acquire the sensor data and save them in the respective sensor data storage sections 62 of the memories 22. For example, in the sensor data storage section 62 of the node device 20A, “sensor data 1-1-1” and “sensor data 1-1-2” which have been acquired by the sensor corresponding to “sensor type IDS=1” of the sensor device 30A corresponding to “sensor device ID=1” are saved. Also, in the sensor data storage section 62 of the node device 20A, “sensor data 1-2-1” and “sensor data 1-2-2” which have been acquired by the sensor corresponding to “sensor type IDS=2” of the sensor device 30A corresponding to “sensor device ID=1” are saved. Further, in the sensor data storage section 62 of the node device 20A, “sensor data 2-3-1”, “sensor data 2-3-2”, “sensor data 2-3-3”, and “sensor data 2-3-4” which have been acquired by the sensor corresponding to “sensor type IDS=3” of the sensor device 30B corresponding to “sensor device ID=2” are saved. Here, the three numbers after “sensor data” indicate, from the left to right in order, the sensor device ID of the sensor device which has acquired the sensor data, the sensor type IDS of the sensor data, and the order the sensor data has been measured. Also in the sensor data storage sections 62 of the node devices 20B and 20C, the sensor data which have been acquired by the sensor device 30D corresponding to “sensor device ID=3” and the sensor data which have been acquired by the sensor device 30F corresponding to “sensor device ID=4” are saved as illustrated in FIG. 7.

In that state, the client PC 10 makes the sensor data acquisition request S to, for example, the node device 20A (NODE ID=X) to request the node device 20A to acquire all of the sensor data of the sensor type “1” (IDS=1) which have been acquired by the plurality of node devices 20A, 20B, 20C, . . . from each of the sensor devices 30. Since the node device 20A stores “NODE ID=X” in the self-ID storage section 61, the node device 20A responds to the sensor data acquisition request S. Specifically, in response to the sensor data acquisition request S, the sensor data search section 51 of the node device 20A searches for the sensor data of “IDS=1” saved in the sensor data storage section 62 while issuing the sensor data acquisition request S to the other node devices 20B and 20C.

The sensor data search section 51 of the node device 20A acquires “sensor data 1-1-1” and “sensor data 1-1-2” from the sensor data storage section 62. On the other hand, in response to the sensor data acquisition request S made by the node device 20A, the node device 20B transmits “sensor data 3-1-1” and “sensor data 3-1-2” in the sensor data storage section 62 to the node device 20A via the LAN communication section 25. Yet on the other hand, since the node device 20C does not save the sensor data which meets the sensor data acquisition request S made by the node device 20A in the sensor data storage section 62, the node device 20C transmits a reply “NOT AVAILABLE” to the node device 20A via the LAN communication section 25.

Then, the LAN communication section 25 of the node device 20A transmits “sensor data 1-1-1” and “sensor data 1-1-2”, “sensor data 3-1-1” and “sensor data 3-1-2”, and “NODE ID=Z, NOT AVAILABLE” to the client PC 10. These data sections are acquired by the memory 12 of the client PC 10.

As a result, the client PC 10 only needs to make the information acquisition request to any of the plurality of node devices 20A, 20B, 20C, . . . (in the above example, the node device 20A) to make the information acquisition request to the node devices. Then, the client PC 10 neither needs to specify each of the plurality of node devices 20A, 20B, 20C, . . . before issuing the information acquisition request nor needs to maintain information about which ones of the node devices save the desired sensor data. Therefore, the client PC 10 can make the information acquisition request to the node devices in a short time by the simple process. Further, any special software program and setting are not required for the client PC 10 and the information acquisition request can be made by a general-purpose computer apparatus such as the client PC 10.

### Second Configuration Example

Now, a second configuration example of the network system 1 will be described.

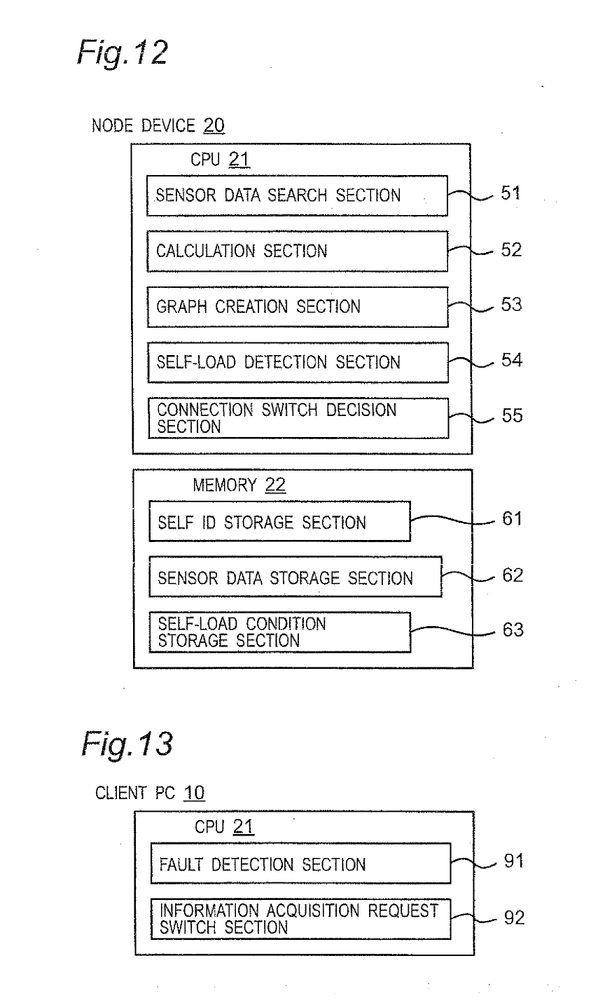

FIG. 12 illustrates constituent elements from the viewpoint of functionality of the CPU 21 and the memory 22 included in the node device 20 in the second configuration example of the network system 1. In FIG. 12, the same constituent elements as those in FIG. 5 are denoted by the same reference numbers as those in FIG. 5 and their description will be omitted.

In the second configuration example, from the viewpoint of functionality, the CPU 21 of each of the node devices 20 has a calculation section 52, a graph creation section 53 as the first graph creation section and the second graph creation section, a self-load detection section 54, and a connection switch decision section 55 as illustrated in FIG. 12 (The calculation section 52, the graph creation section 53, the self-load detection section 54, and the connection switch decision section 55 are implemented as software programs.). The memory 22 of each of the node devices 20 has a self-load condition storage section 63. The calculation section 52 and the graph creation section 53 will be described later.

Every certain period of time, the self-load detection section 54 in each of the node devices 20 detects the load on the node device 20. In this example, the self-load detection section 54 detects mean values C11, C12, . . . of the utilization rate of the CPU 21 included in the node device 20 for respective time slots □t1, □t2, . . . of five minutes each as the certain period as the load on the node device 20 (The utilization rate of the CPU 21 may range from 0% to 100% inclusive according to the operation situation.). Then, the self-load detection sections 54 of the plurality of node devices 20A, 20B, 20C, . . . collectively function as a node load detection section in synchronization with each other to detect the loads on the node devices 20A, 20B, 20C, . . . for the respective time slots □t1, □t2, . . . .

The self-load condition storage section 63 of each of the node devices 20 stores the detected load on the node device 20 which includes the self-load condition storage section 63. Then, the self-load condition storage sections 63 of the plurality of node devices 20A, 20B, 20C, . . . are synchronized with each other to store the loads on the node devices 20A, 20B, 20C, . . . for the respective time slots □t1, □t2, . . . .

In this example, it is assumed that the utilization rate (mean value) of the CPU of the node device 20A as the third node device which receives the information acquisition request among the plurality of node devices 20A, 20B, 20C, . . . in FIG. 1 is above the upper limit (in this example, 70%) whereas the utilization rate (mean value) of the CPU of the node device 20B as the fourth node device which does not receive the information acquisition request is below the lower limit (in this example, 30%).

In that case, the connection switch decision section 55 (see FIG. 12) provided for the node device 20A and the connection switch decision section 55 provided for the node device 20B inform each other of the self-load conditions stored in the respective self-load condition storage sections 63 and make a decision about switching the node device to respond to the information acquisition request between the node device 20A and the node device 20B to level out the loads between the node device 20A and the node device 20B. In this example, the connection switch decision sections 55 switch the node device to respond to the information acquisition request from the node device 20A which receives the information acquisition request to the node device 20B which has the smallest load. As a result, the configuration can level out the loads among the plurality of node devices (in the above example, between the node device 20A and the node device 20B).

Further, the node device 20B which is set as the node device to respond to the information acquisition request and another node device (for example, 20D) inform each other of their self-load conditions and make a decision about switching the node device to respond to the information acquisition request between the node device 20C and the node device 20D to level out the loads between the node device 20C and the node device 20D. In that manner, the decision about switching the node device to respond to the information acquisition request between the two node devices was made one after the other.

Consequently, the configuration can improve the performance of the whole of the network system 1. For example, the configuration can avoid a situation in which any of the plurality of node devices 20A, 20B, 20C, . . . has a trouble in replying to the client PC 10. Further, the network system 1 can always keep good performance even if the condition of the radio wave for the wireless communication, the network traffic, and the number of sensor data collected by each sensor device change every moment.

That is, the network system 1 can equalize the response times, otherwise the client PC 10 requesting the data may obtain a prompt response in some situations but not in others. Therefore, the user can more easily make a work plan.

Further, since the network system 1 can effectively level out the loads among the plurality of node devices 20A, 20B, 20C, . . . , the user does not need to previously set a target of the information acquisition request among the plurality of node devices 20A, 20B, 20C, . . . before the information acquisition request was made. Therefore, the user can easily achieve the information acquisition.

Further, even if any of the plurality of node devices 20A, 20B, 20C, is broken down, for example, the network system 1 can make the decision without interruption by using the node device other than the broken node device since the function is not concentrated in a particular node device. Still further, even if any of the plurality of node devices 20A, 20B, 20C, . . . is replaced by a new model node device, the network system 1 can promptly carry out the changeover since the new model node device is not required to have a particular function different from that of the other node devices.

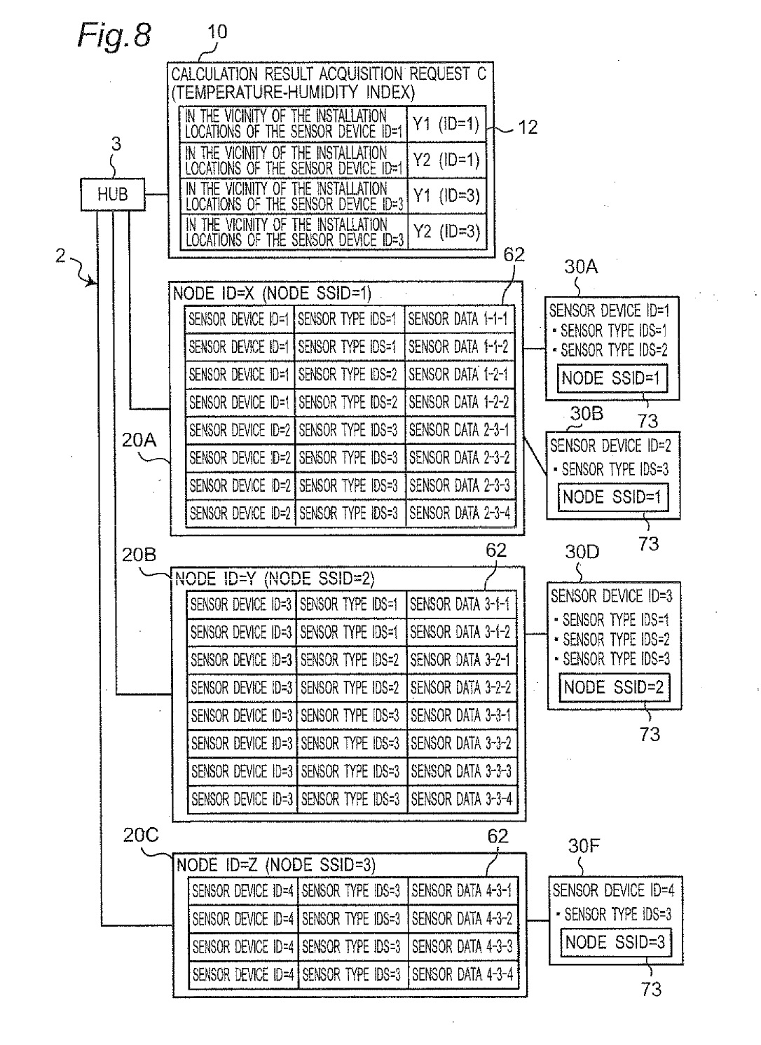

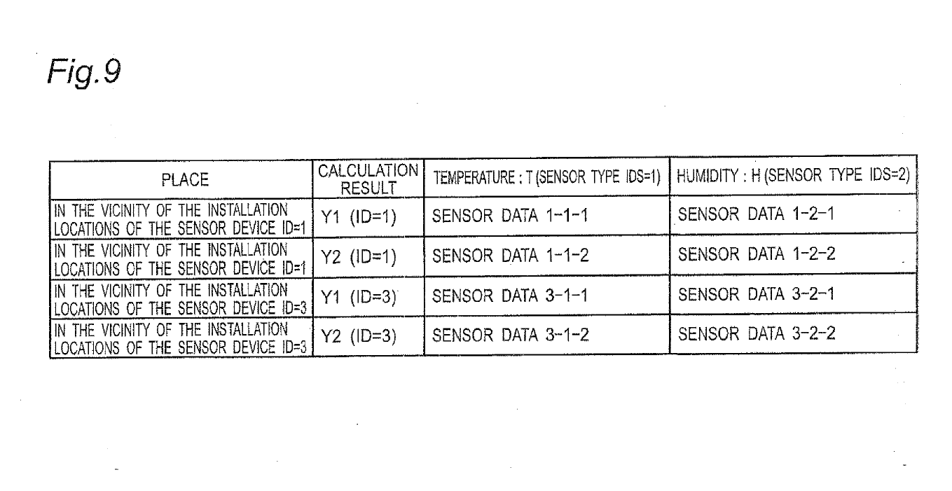

Now, a case that the client PC 10 requests and acquires the calculation result data from the node device by operating the calculation section 52 illustrated in FIG. 12 will be described with reference to FIGS. 8 and 9 (The reference symbols in FIGS. 4, 6, and 12 will be used as required).

The calculation section 52 of each of the node devices 20 gets the calculation result data to meet the information acquisition request by performing a calculation based on the sensor data acquired by the sensor data search section 51. Then, the LAN communication section 25 (see FIG. 3) of each of the node devices 20 transmits the calculation result data calculated by the calculation section 52 based on the sensor data acquired by the sensor data search section 51 to the client PC 10.

As illustrated in FIG. 8, the sensor devices 30A, 30B, 30D, and 30F, the node devices 20A, 20B, and 20C, and the client PC 10 are connected in the same manner as illustrated in FIG. 7. The sensor data storage sections 62 of the node devices 20A, 20B, and 20C save the sensor data in the same manner as illustrated in FIG. 7.

In that state, the client PC 10 makes a calculation result acquisition request C as the first information acquisition request to, for example, the node device 20A (NODE ID=X) as the first node device for temperature-humidity index in the vicinity of the installation locations of the sensor device 30A (sensor device ID=1) and the sensor device 30D (sensor device ID=3). Specifically, the client PC 10 specifies the sensor data (temperature: T) of the sensor type “1” (IDS=1) and the sensor data (humidity: H) of the sensor type “2” (IDS=2) and makes the calculation result acquisition request C for the temperature-humidity index acquired on the basis of these sensor data. The arithmetic equation for calculating the temperature-humidity index is shown below.

Y=0.81T+0.01H(0.99T−143)+46.3 (1)

In response to the calculation result acquisition request C, the sensor data search section 51 of the node device 20A searches for the sensor data corresponding to “IDS=1” and “IDS=2” from “sensor ID=1” and “sensor ID=3”, respectively, saved in the sensor data storage section 62 while issuing the sensor data acquisition request S to the other node devices 20B and 20C.

The sensor data search section 51 of the node device 20A acquires “sensor data 1-1-1”, “sensor data 1-1-2”, “sensor data 1-2-1”, and “sensor data 1-2-2” from the sensor data storage section 62. On the other hand, in response to the sensor data acquisition request S made by the node device 20A, the node device 20B transmits “sensor data 3-1-1”, “sensor data 3-1-2”, “sensor data 3-2-1”, and “sensor data 3-2-2” saved in the sensor data storage section 62 to the node device 20A via the LAN communication section 25. Yet on the other hand, since the node device 20C does not save the sensor data which meets the sensor data acquisition request S made by the node device 20A in the sensor data storage section 62, the node device 20C transmits a reply “NOT AVAILABLE” to the node device 20A via the LAN communication section 25.

Next, based on the sensor data acquired by the sensor data search section 51, the calculation section 52 of the node device 20A calculates the temperature-humidity index by using the above equation (1). In this example, the calculation section 52 finds a calculation result Y1 (ID=1) for the temperature-humidity index in the vicinity of the installation location of the sensor device 30A based on “sensor data 1-1-1” and “sensor data 1-2-1” as shown in FIG. 9. Also, the calculation section 52 finds a calculation result Y2 (ID=1) for the temperature-humidity index based on “sensor data 1-1-2” and “sensor data 1-2-2”. Further, the calculation section 52 finds the calculation result Y1 (ID=3) for the temperature-humidity index in the vicinity of the installation location of the sensor device 301D based on “sensor data 3-1-1” and “sensor data 3-2-1”. Also, the calculation section 52 finds the calculation result Y2 (ID=3) for the temperature-humidity index based on “sensor data 3-1-2” and “sensor data 3-2-2”.

Then, the LAN communication section 25 of the node device 20A transmits the calculation results Y1 (ID=1), Y2 (ID=1), Y1 (ID=3), and Y2 (ID=3) for the temperature-humidity index to the client PC 10.

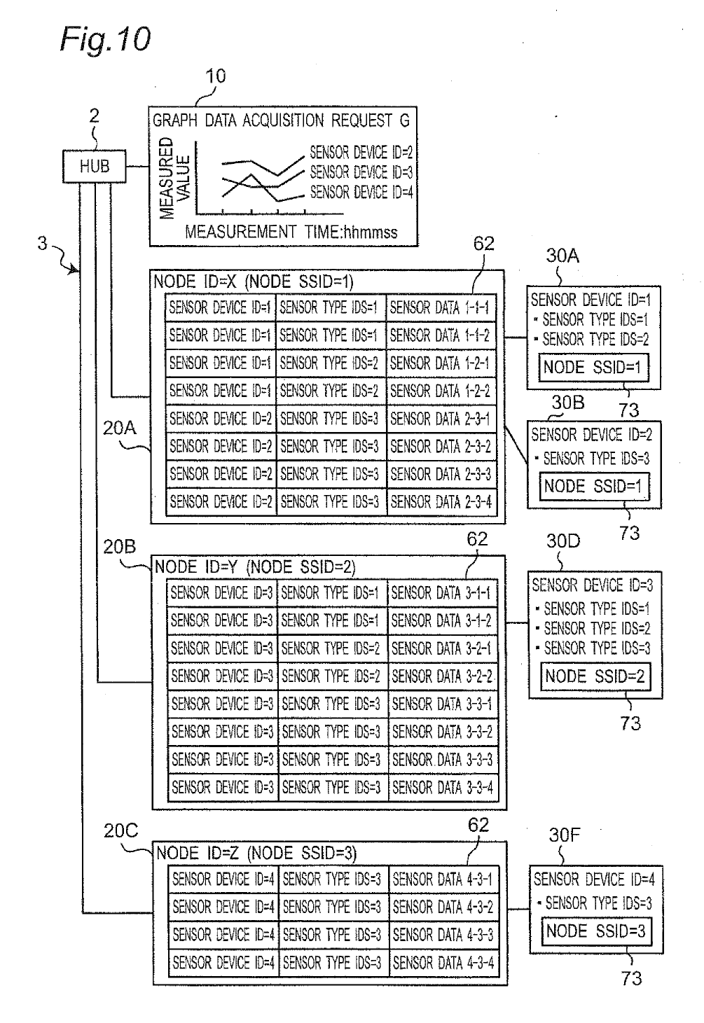

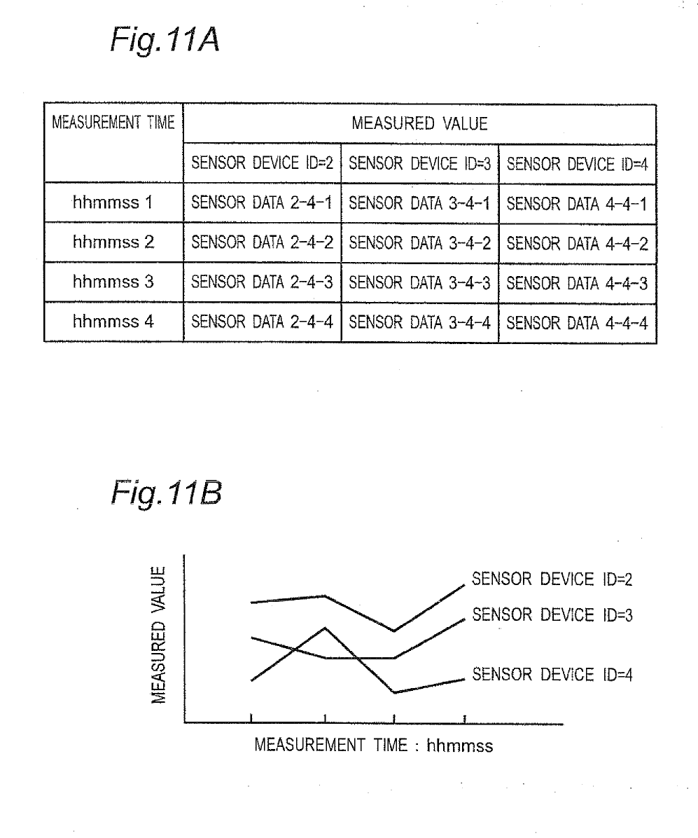

Now, a case that the client PC 10 requests and acquires data of the graph from the node devices by operating the graph creation section 53 illustrated in FIG. 12 will be described with reference to FIGS. 10, 11A, and 11B (The reference symbols in FIGS. 4, 6, and 12 will be used as required).

The graph creation section 53 of each of the node devices 20 creates the data of the graph to meet the information acquisition request based on the sensor data acquired by the sensor data search section 51. Then, the LAN communication section 25 (see FIG. 3) of each of the node devices 20 transmits the data of the graph created by the graph creation section 53 based on the sensor data acquired by the sensor data search section 51 to the client PC 10.

As illustrated in FIG. 10, the sensor devices 30A, 30B, 30D, and 30F, the node devices 20A, 20B, and 20C, and the client PC 10 are connected in the same manner as illustrated in FIG. 7. The sensor data storage sections 62 of the node devices 20A, 20B, and 20C save the sensor data in the same manner as illustrated in FIG. 7.

In that state, the client PC 10 makes a graph data acquisition request G as the second information acquisition request to, for example, the node device 20C (NODE ID=Z) as the second node device for a graph showing time series variations of the electric energies measured by the sensor device 30B (sensor device ID=2), the sensor device 30D (sensor device ID=3), and the sensor device 30F (sensor device ID=4). Specifically, the client PC 10 specifies the sensor data (electric energy) of the sensor type “3” (IDS=3) and makes the data of the graph acquisition request G for the graph showing the comparison of the time series variations of the electric energies acquired on the basis of the sensor data among the respective sensor devices (sensor device IDs=2, 3, 4).

In response to the data of the graph acquisition request G, the sensor data search section 51 of the node device 20C searches for the sensor data of “IDS=3” saved in the sensor data storage section 62 while issuing the sensor data acquisition request to the other node devices 20A and 20B.

The sensor data search section 51 of the node device 20C acquires “sensor data 4-3-1”, “sensor data 4-3-2”, “sensor data 4-3-3”, and “sensor data 4-3-4” from the sensor data storage section 62. On the other hand, in response to the sensor data acquisition request made by the node device 20C, the node device 20A transmits “sensor data 2-3-1”, “sensor data 2-3-2”, “sensor data 2-3-3”, and “sensor data 2-3-4” saved in the sensor data storage section 62 to the node device 20C via the LAN communication section 25. Also, in response to the sensor data acquisition request made by the node device 20C, the node device 20B transmits “sensor data 3-3-1”, “sensor data 3-3-2”, “sensor data 3-3-3”, and “sensor data 3-3-4” saved in the sensor data storage section 62 to the node device 20C via the LAN communication section 25.

The sensor data acquired by the sensor data search section 51 are the electric energies measured by the respective sensor devices (sensor device IDs=2, 3, 4) at the respective measurement time-of-days hhmmss1 to hhmmss4 as shown in FIG. 11A. Then, the graph creation section 53 of the node device 20C creates graphs showing the time series variations of the electric energies measured by the respective sensor devices from the sensor data as shown in FIG. 11B. In FIG. 11B, the axis of abscissas represents the measurement time-of-day hhmmss and the axis of ordinate represents the measured value of the electric energy.

Next, the LAN communication section 25 of the node device 20C transmits image data of the graph to the client PC 10 as illustrated in FIG. 10. Therefore, the client PC 10 can access the graph by neither taking trouble nor spending time in creating the graph based on the sensor data acquired by the sensor data search section or the calculation result data acquired on the basis of the sensor data.

The client PC 10 can make the calculation result acquisition request C as the first information acquisition request to the node device 20A as the first node device as described with reference to FIGS. 8 and 9 in parallel with the data of the graph acquisition request G as the second information acquisition request to the node device 20C as the second node device as described with reference to FIGS. 10, 11A, and 11B. As a result, the embodiment can distribute the loads among the plurality of node devices (in the above example, between the node device 20A and the node device 20C). Therefore, the embodiment can improve the performance of the whole network system.

### Third Configuration Example

Now, a third configuration example of the network system 1 will be described.

FIG. 13 illustrates constituent elements from the viewpoint of functionality of the CPU 11 included in the client PC 10 in the third configuration example of the network system 1. The CPU 11 has a fault detection section 91 and an information acquisition request switch section 92 (The fault detection section 91 and the information acquisition request switch section 92 are implemented as software programs.). The fault detection section 91 of the client PC 10 detects a fault in the connection between the client PC 10 and the node device to which the information acquisition request was made. When the fault detection section 91 detected the fault, the information acquisition request switch section 92 of the client PC 10 stops to make the information acquisition request to any of the node devices 20A, 20B, 20C to which the information acquisition request was made and makes the information acquisition request to any of the plurality of node devices other than the node device to which the information acquisition request was made.

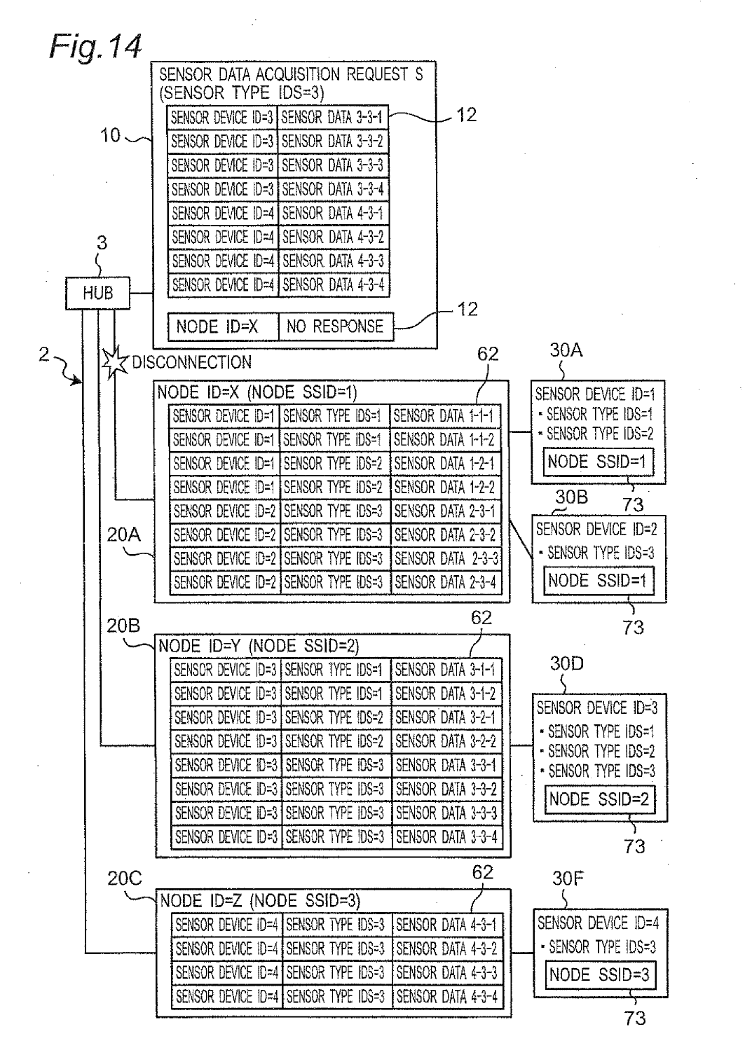

Now, processes in which the client PC 10 makes a sensor data acquisition request S to the node device 20B when a fault occurred in the connection between the client PC 10 and the node device 20A to which the sensor data acquisition request S was made will be described with reference to FIG. 14 (The reference symbols in FIGS. 5, 6 and 13 will be used as required.).

As illustrated in FIG. 14, the sensor devices 30A, 30B, 30D, and 30F, the node devices 20A, 20B, and 20C, and the client PC 10 are connected in the same manner as illustrated in FIG. 7. The sensor data storage sections 62 of the node devices 20A, 20B, and 20C save the sensor data in the same manner as illustrated in FIG. 7.

In that state, the client PC 10 makes the sensor data acquisition request S to the node device 20A (NODE ID=X) for the sensor data of the sensor type “3” (IDS=3).

It is assumed that the LAN 2 between the client PC 10 and the node device 20A has been disconnected when the client PC 10 makes the sensor data acquisition request S. Since the data sections have not arrived at the client PC 10 from the LAN communication section 25 of the node device 20A in a predetermined time period (for example, one minute) after the issuance of the sensor data acquisition request S, the fault detection section 91 of the client PC 10 determines that a fault has occurred in the connection between the client PC 10 and the node device 20A. As a result, the fault detection section 91 can more certainly detect the fault.

When the fault detection section 91 detected the fault, the information acquisition request switch section 92 of the client PC 10 stops to make the sensor data request S to the node device 20A, switches to the node device 20B from the node device 20A, and makes the sensor data acquisition request S to the node device 20B.

The sensor data search section 51 of the node device 20B searches for the sensor data of “IDS=3” saved in the sensor data storage section 62 while issuing the sensor data acquisition request S to the node device 20C. Due to the fault, the node device 20A cannot receive the sensor data acquisition request S made by the node device 20B.

The sensor data search section 51 of the node device 20B acquires “sensor data 3-3-1”, “sensor data 3-3-2”, “sensor data 3-3-3”, and “sensor data 3-3-4” from the sensor data storage section 62. On the other hand, in response to the sensor data acquisition request S made by the node device 20B, the node device 20C transmits “sensor data 4-3-1”, “sensor data 4-3-2”, “sensor data 4-3-3”, and “sensor data 4-3-4” saved in the sensor data storage section 62 to the node device 20B via the LAN communication section 25.

Then, the LAN communication section 25 of the node device 20B transmits “sensor data 3-3-1”, “sensor data 3-3-2”, “sensor data 3-3-3”, and “sensor data 3-3-4” and “sensor data 4-3-1”, “sensor data 4-3-2”, “sensor data 4-3-3”, and “sensor data 4-3-4”, and “NODE ID=X, NO RESPONSE” indicating that no response has been received from the node device 20A to the client PC 10.

In that manner, in the third configuration example, even if the fault is detected, the information acquisition request switch section 92 switches the node device 20A to the node device 20B other than the node device 20A and automatically makes the sensor data acquisition request S to the node device 20B. As a result, fault-tolerance can be realized.

Although the network system 1 includes one client PC 10 as a computer apparatus in the above described embodiments, the network system 1 is not limited to that. The network system 1 may include a plurality of client devices or various types of computers which can communicate via a network such as a server device and a host computer.

Although it is assumed that one client PC 10 as a computer apparatus and the node devices 20A, 20B, 20C, . . . are connected by the LAN 2 as a network in the above described embodiments, the network is not limited to that. The network connecting the computer apparatus and the node device may be a computer network such as a wide area network (WAN) or the Internet and it may be wired or wireless.

Although each of the node devices 20A, 20B, and 20C has SSID for identifying the wireless LAN in the above described embodiments, the identifier is not limited to that. Any identifier may be used as far as it can identify the wireless LAN from LANs of the other networks.

Although each of the plurality of node devices 20A, 20B, 20C, . . . is accessible by one or more sensor devices 30A, 30B, 30C, 30D, 30E, 30F, 30G, . . . via Wi-Fi (registered trademark) as the wireless LAN in the above described embodiments, the present invention is not limited to that. The sensor devices only need to be communicatively connected to the node devices whether the connection is wired or wireless.

Although the graph creation section 53 of the node device creates the graph from the sensor data measured by the sensor devices 30B, 30D, and 30F in the above described embodiments, the present invention is not limited to that. The graph creation section 53 may create the graph from other sensor data or the calculation result calculated on the basis of the sensor data.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF REFERENCE NUMERALS

1: Network system
2: LAN
10: Client PC
14: LCD indication section
16: Input device
20, 20A, 20B, 20C: Node device
30, 30A, 30B, 30C, 30D, 30E, 30F, 30G: Sensor device
S: Sensor data acquisition request
C: Calculation result acquisition request
G: Graph data acquisition request

1. A network system comprising:
at least one computer apparatus and
a plurality of node devices are communicatively connected to each other via a network,
wherein each of the plurality of node devices is accessible by one or more sensor devices via a wireless communication or wired communication,
wherein each of the node devices acquires sensor data from the sensor device connected to the node device itself and saves the sensor data in a sensor data storage section included in the node device itself,
wherein the computer apparatus makes an information acquisition request by specifying the sensor data from any one or more of the one or more sensor devices and acquires the sensor data from any of the plurality of node devices via the network,
wherein the computer apparatus makes the information acquisition request to any of the plurality of node devices, and
wherein each of the node devices comprises:
a sensor data search section for searching the sensor data storage sections of the plurality of node devices for the sensor data according to the information acquisition request and acquiring the sensor data, when the computer apparatus made the information acquisition request to the node device itself; and
an information transmission section for transmitting the sensor data acquired by the sensor data search section to the computer apparatus.

2. The network system according to claim 1,
wherein each of the plurality of node devices further comprises a calculation section for getting calculation result data by performing a calculation based on the sensor data acquired by the sensor data search section,
wherein the computer apparatus makes the information acquisition request by specifying the calculation result data, and
wherein the information transmission section of the node device which holds the calculation result data specified by the computer apparatus transmits the calculation result data to the computer apparatus.

3. The network system according to claim 1,
wherein each of the node devices further comprises a first graph creation section for creating a graph based on the sensor data acquired by the sensor data search section,
wherein the computer apparatus makes the information acquisition request by specifying data of the graph, and
wherein the information transmission section of the node device which holds the data of the graph specified by the computer apparatus transmits the data of the graph to the computer apparatus.

4. The network system according to claim 2,
wherein each of the node devices further comprises a second graph creation section for creating a graph based on the calculation result data calculated by the calculation section,
wherein the computer apparatus makes the information acquisition request by specifying data of the graph, and
wherein the information transmission section of the node device which holds the data of the graph specified by the computer apparatus transmits the data of the graph to the computer apparatus.

5. The network system according to claim 1, wherein the computer apparatus makes a first information acquisition request to a first node device among the plurality of node devices and concurrently makes a second information acquisition request different from the first information acquisition request to a second node device different from the first node device.

6. The network system according to claim 1, wherein the network system further comprises:
a node load detection section for detecting a load on each of the node devices every certain period of time, and
a load leveling section for switching the node device that received the information acquisition request to a proper node device for responding to the information acquisition request to level out the loads among the plurality of node devices.

7. The network system according to claim 6,
wherein the load leveling section includes a decision section provided for each of the plurality of node devices, and
wherein the decision section provided for a third node device and the decision section provided for a fourth node device among the plurality of node devices make a decision about switching the node device to respond to the information acquisition request between the third node device and the fourth node device to level out the loads between the third node device and the fourth node device.

8. The network system according to claim 1, wherein the computer apparatus comprises:
a fault detection section for detecting a fault in a connection between the computer apparatus and the node device to which the information acquisition request was made; and
an information acquisition request switch section for stopping to make the information acquisition request to the node device to which the information acquisition request was made and making the information acquisition request to any of the plurality of node devices other than the node device to which the information acquisition request was made, when the fault detection section detected the fault.

9. The network system according to claim 8, wherein the fault detection section determines that the fault occurred when data was not transmitted from the information transmission section within a predetermined time period after the information acquisition request was made.

10. A node device group comprising:
a plurality of node devices in a network system wherein at least one computer apparatus and
a plurality of node devices are communicatively connected to each other via a network,
wherein each of the plurality of node devices is accessible by one or more sensor devices via wireless communication or wired communication,
wherein each of the node devices acquires a sensor data from the sensor device connected to the node device and saves the sensor data in a sensor data storage section included in the node device itself,
wherein the computer apparatus makes an information acquisition request by specifying the sensor data from any one or more of the one or more sensor devices and acquires the sensor data from any of the plurality of node devices via the network,
wherein the computer apparatus makes the information acquisition request to any of the plurality of node devices, and wherein each of the node devices comprises:
a sensor data search section for searching the sensor data storage sections of the plurality of node devices for the sensor data according to the information acquisition request and acquiring the sensor data, when the computer apparatus made the information acquisition request to the node device itself; and
an information transmission section for transmitting the sensor data acquired by the sensor data search section to the computer apparatus.

11. A computer apparatus in a network system comprising:
at least one computer apparatus and
a plurality of node devices are communicatively connected to each other via a network, each of the plurality of node devices is accessible by one or more sensor devices via wireless communication or wired communication,
wherein each of the node devices acquires a sensor data from the sensor device connected to the node device itself and saves the sensor data in a sensor data storage section included in the node device itself,
wherein the computer apparatus makes an information acquisition request by specifying the sensor data from any one or more of the one or more sensor devices and acquires the sensor data from any of the plurality of node devices via the network, and
wherein each of the node devices comprises:
a sensor data search section for searching the sensor data storage sections of the plurality of node devices for the sensor data according to the information acquisition request and acquiring the sensor data, when the computer apparatus made the information acquisition request to the node device itself; and
an information transmission section for transmitting the sensor data acquired by the sensor data search section to the computer apparatus, wherein the computer apparatus makes the information acquisition request to any of the plurality of node devices.

12. A method for transmitting and receiving sensor data in a network system wherein at least one computer apparatus and a plurality of node devices are communicatively connected to each other via a network, each of the plurality of node devices is accessible by one or more sensor devices via wireless communication or wired communication,
wherein each of the node devices acquires a sensor data from the sensor device connected to the node device itself and saves the sensor data in a sensor data storage section included in the node device itself,
wherein the computer apparatus makes an information acquisition request by specifying the sensor data from any one or more of the one or more sensor devices and acquires the sensor data from any of the plurality of node devices via the network, and
wherein the method for transmitting and receiving sensor data comprises steps of:
causing the computer apparatus to make the information acquisition request to any of the plurality of node devices;
causing a sensor data search section of the node device to which the information acquisition request was made to search the sensor data storage sections of the plurality of node devices for the sensor data according to the information acquisition request and to acquire the sensor data; and
causing an information transmission section of the node device to which the information acquisition request was made to transmit the sensor data acquired by the sensor data search section to the computer apparatus.

13. The network system according to claim 1,
wherein each of the plurality of node devices further comprises a calculation section for getting calculation result data by performing a calculation based on the sensor data acquired by the sensor data search section,
wherein the computer apparatus makes the information acquisition request by specifying the calculation result data,
wherein the information transmission section of the node device which holds the calculation result data specified by the computer apparatus transmits the calculation result data to the computer apparatus,
wherein each of the node devices further comprises a first graph creation section for creating a graph based on the sensor data acquired by the sensor data search section, and
wherein each of the node devices further comprises a second graph creation section for creating a graph based on the calculation result data calculated by the calculation section.

14. The network system according to claim 13,
wherein the computer apparatus makes the information acquisition request by specifying data of the graph, and
wherein the information transmission section of the node device which holds the data of the graph specified by the computer apparatus transmits the data of the graph to the computer apparatus.

15. The network system according to claim 14, wherein the computer apparatus makes a first information acquisition request to a first node device among the plurality of node devices and concurrently makes a second information acquisition request different from the first information acquisition request to a second node device different from the first node device

16. The network system according to claim 15, wherein the network system further comprises:
a node load detection section for detecting a load on each of the node devices every certain period of time, and
a load leveling section for switching the node device that received the information acquisition request to a proper node device for responding to the information acquisition request to level out the loads among the plurality of node devices.

17. The network system according to claim 16,
wherein the load leveling section includes a decision section provided for each of the plurality of node devices, and
wherein the decision section provided for a third node device and the decision section provided for a fourth node device among the plurality of node devices make a decision about switching the node device to respond to the information acquisition request between the third node device and the fourth node device to level out the loads between the third node device and the fourth node device.

18. The network system according to claim 16, wherein the network system further comprises:
a fault detection section for detecting a fault in a connection between the computer apparatus and the node device to which the information acquisition request was made; and
an information acquisition request switch section for stopping to make the information acquisition request to the node device to which the information acquisition request was made and making the information acquisition request to any of the plurality of node devices other than the node device to which the information acquisition request was made, when the fault detection section detected the fault.

19. The network system according to claim 18, wherein the fault detection section determines that the fault occurred when data was not transmitted from the information transmission section within a predetermined time period after the information acquisition request was made.
